(19) United States
(12) Patent Application Publication
(10) Pub. No.: US 2026/0136376 A1
(43) Pub. Date: May 14, 2026

(54) METHOD AND APPARATUS FOR TRANSMITTING AND RECEIVING IDENTIFICATION INFORMATION OF UNMANNED AERIAL VEHICLE USER EQUIPMENT IN WIRELESS COMMUNICATION SYSTEM

(71) Applicant: Samsung Electronics Co., Ltd., Suwon-si, Gyeonggi-do (KR)

(72) Inventors: Hyunjeong KANG, Suwon-si (KR); Sangyeob JUNG, Suwon-si (KR)

(21) Appl. No.: 19/119,592

(22) PCT Filed: Oct. 11, 2023
(86) PCT No.: PCT/KR2023/015556

§ 371 Date: Apr. 9, 2025

(30) Foreign Application Priority Data
Oct. 11, 2022 (KR) 10-2022-0129983

(51) Int. Cl. H04W 72/25; H04W 4/44; H04W 8/20

(52) U.S. Cl. CPC H04W 72/25; H04W 4/44; H04W 8/20

(57) ABSTRACT

The present disclosure relates to a 5G or 6G communication system for supporting higher data transmission rates. The present disclosure provides a method performed by a first user equipment (UE) in a wireless communication system, the method comprising the steps of: obtaining, through a sidelink, bearer configuration information for a radio bearer, for unmanned aerial vehicle (UAV) control information; configuring, on the basis of the configuration information, the radio bearer for first UAV control information transmitted from the first UE to a second UE and second UAV control information transmitted from the second UE to the first UE; and transmitting the first UAV control information to the second UE by using the configured radio bearer, wherein the configuring of the radio bearer comprises, on the basis of the bearer configuration information, configuring one radio bearer that is commonly used for the first UAV control information and the second UAV control information or configuring at least one radio bearer on the basis of a cast type or quality of service (QoS) profile of the first UAV control information and the second UAV control information.

### TECHNICAL FIELD

The disclosure relates to a wireless communication system and, more particularly, to a method and device for transmitting and receiving identification information of an unmanned aerial vehicle terminal in a wireless communication system.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Embodiments set forth herein are to provide a device and a method capable of effectively providing services in a wireless communication system.

### Solution to Problem

According to an embodiment of the disclosure, a method performed by a first terminal (user equipment (UE)) in a wireless communication system may include: acquiring bearer configuration information for a radio bearer for unmanned aerial vehicle (UAV) control information via a sidelink; based on the configuration information, configuring a radio bearer for first UAV control information transmitted from the first UE to a second UE and second UAV control information transmitted from the second UE to the first UE; and transmitting the first UAV control information to the second UE by using the configured radio bearer, wherein the configuring of the radio bearer includes, based on the bearer configuration information, configuring one radio bearer that is commonly used for the first UAV control information and the second UAV control information, or configuring at least one radio bearer, based on a cast type or a quality of service (QoS) profile of the first UAV control information and the second UAV control information.

In addition, according to an embodiment of the disclosure, a method performed by a second terminal (user equipment (UE)) in a wireless communication system may include: acquiring bearer configuration information for a radio bearer for unmanned aerial vehicle (UAV) control information via a sidelink; based on the configuration information, configuring a radio bearer for first UAV control information transmitted from a first UE to the second UE and second UAV control information transmitted from the second UE to the first UE; and receiving the first UAV control information from the first UE by using the configured radio bearer, wherein the configuring of the radio bearer includes, based on the bearer configuration information, configuring one radio bearer that is commonly used for the first UAV control information and the second UAV control information, or configuring at least one radio bearer, based on a cast type or a quality of service (QoS) profile of the first UAV control information and the second UAV control information.

In addition, according to an embodiment of the disclosure, a first terminal (user equipment (UE)) in a wireless communication system may include a transceiver, and a controller connected to the transceiver, wherein the controller is configured to perform: acquiring bearer configuration information for a radio bearer for unmanned aerial vehicle (UAV) control information via a sidelink; based on the configuration information, configuring a radio bearer for first UAV control information transmitted from the first UE to a second UE and second UAV control information transmitted from the second UE to the first UE; and transmitting the first UAV control information to the second UE by using the configured radio bearer, wherein the configuring of the radio bearer includes, based on the bearer configuration information, configuring one radio bearer that is commonly used for the first UAV control information and the second UAV control information, or configuring at least one radio bearer, based on a cast type or a quality of service (QoS) profile of the first UAV control information and the second UAV control information.

In addition, according to an embodiment of the disclosure, a second terminal (user equipment (UE)) in a wireless communication system may include a transceiver, and a controller connected to the transceiver, wherein the controller is configured to perform: acquiring bearer configuration information for a radio bearer for unmanned aerial vehicle (UAV) control information via a sidelink; based on the configuration information, configuring a radio bearer for first UAV control information transmitted from a first UE to the second UE and second UAV control information transmitted from the second UE to the first UE; and receiving the first UAV control information from the first UE by using the configured radio bearer, wherein the configuring of the radio bearer includes, based on the bearer configuration information, configuring one radio bearer that is commonly used for the first UAV control information and the second UAV control information, or configuring at least one radio bearer, based on a cast type or a quality of service (QoS) profile of the first UAV control information and the second UAV control information.

### Advantageous Effects of Invention

Embodiments set forth herein provide a device and a method capable of effectively providing services in a wireless communication system.

Advantageous effects obtainable from the disclosure may not be limited to the above-mentioned effects, and other effects which are not mentioned may be clearly understood from the following descriptions by those skilled in the art to which the disclosure pertains.

### BRIEF DESCRIPTION OF DRAWINGS

FIG. 1 is a diagram illustrating a scenario supporting unmanned vehicles in a wireless communication system according to an embodiment of the disclosure.

FIG. 2 is a diagram illustrating a scenario supporting unmanned vehicles in the wireless communication system according to an embodiment of the disclosure.

FIG. 3 is a diagram illustrating a scenario supporting unmanned vehicles in the wireless communication system according to an embodiment of the disclosure.

FIG. 4 is a diagram illustrating a signal flow of UEs in a scenario supporting unmanned vehicles in the wireless communication system according to an embodiment of the disclosure.

FIG. 5 is a diagram illustrating a signal flow of UEs in a scenario supporting unmanned vehicles in the wireless communication system according to an embodiment of the disclosure.

FIG. 6 is a block diagram illustrating a structure of a UE according to an embodiment of the disclosure.

FIG. 7 is a block diagram illustrating a structure of a base station according to an embodiment of the disclosure.

FIG. 8 is a block diagram illustrating a structure of a core network according to an embodiment of the disclosure.

### MODE FOR THE INVENTION

Hereinafter, exemplary embodiments of the disclosure will be described in detail with reference to the accompanying drawings. It should be noted that, in the accompanying drawings, the same or like elements are designated by the same or like reference signs as much as possible. Also, a detailed description of known functions or configurations that may make the subject matter of the disclosure unnecessarily unclear will be omitted.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the 5G system, a network data collection and analysis function (NWDAF), which is a network function for analyzing and providing data collected in a 5G network, may be defined to support network automation. The NWDAF may collect/store/analyze information from the 5G network and provide the results to unspecified network functions (NFs), and the analysis results may be used independently in each NF.

In the following description, some of terms and names defined in the 3rd generation partnership project long term evolution (3GPP LTE) standards (standards for 5G, NR, LTE, or similar systems) may be used for the convenience of description. However, the disclosure is not limited by these terms and names, and may be applied in the same way to systems that conform other standards.

In the following description, terms referring to signals, terms referring to channels, terms referring to control information, terms referring to network entities, terms referring to device elements, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. However, they are merely examples thereof, and the base station and the terminal are not limited to these examples. In the disclosure, the term “eNB” may be interchangeably used with the term “gNB” for the sake of descriptive convenience. That is, a base station described as “eNB” may refer to “gNB”. In the disclosure, the term “terminal” may refer to not only mobile phones, NB-IoT devices, and sensors, but also various wireless communication devices.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

Furthermore, as used in the disclosure, the expression “greater than” or “less than” is used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

Furthermore, the embodiments of the disclosure will be described using terms employed in some communication standards (e.g., the 3rd generation partnership project (3GPP)), but they are for illustrative purposes only. The embodiments of the disclosure may be easily applied to other communication systems through modifications.

UE-to-UE direct communication (sidelink communication) using a 5G communication system is being studied, and it is expected that the UE-to-UE direct communication is applied to, for example, vehicle-to-everything (hereinafter, referred to as “V2X”), a public safety network, and drone communication and may thus provide various services to a user.

An embodiment of the disclosure is to provide a device and method capable of transmitting identification information of an unmanned aerial vehicle in a wireless communication system supporting unmanned aerial vehicles.

An embodiment of the disclosure is to provide a device and method capable of transmitting control information for controlling an unmanned aerial vehicle in the wireless communication system supporting unmanned aerial vehicles.

According to an embodiment of the disclosure, a wireless communication system may monitor and control drone communication so as to provide safe drone communication.

The disclosure may provide a method and device using a direct communication interface (e.g., PC5, sidelink) between UEs to control an unmanned aerial vehicle (UAV) (e.g., a drone) or control an unmanned air mobility (e.g., an urban air mobility (UAM)) in a wireless communication system. In the disclosure, a scenario using a device-to-device direct communication interface may include a procedure in which an agency (e.g., an agency in charge of law enforcement, such as the Federal Aviation Administration of the United States) regulating unmanned aerial vehicles or urban air mobilities acquires UAV identification information or UAM identification information of unmanned aerial vehicles or urban air mobilities. According to regulatory policies, a UE mounted on an unmanned aerial vehicle may transmit UAV identification information to a UE managed by a regulatory agency.

According to an embodiment, a UE may transfer UAV identification information or UAM identification information via a device-to-device direct communication interface. In the disclosure, in addition to a message including UAV identification information or UAM identification information, messages including information required for controlling an unmanned aerial vehicle or an urban air mobility may be defined as UAV control signaling. Of course, the disclosure is not limited to the example above, and UAV control signaling may further include various messages.

A UE mounted on an unmanned aerial vehicle, a UE mounted on an urban air mobility, or a UE managed by a regulatory agency (law enforcement agency) may transmit, receive, and process UAV control signaling including required control information via a device-to-device direct communication interface. An example of a scenario in which UAV control signaling may be operated according to various embodiments of the disclosure may include UE identifier broadcast control and collision detection and collision avoidance control as follows.

TABLE 1

Use of U2X (UAV to everything) for BRID (broadcast
remote identification):
the content of the messages for BRID are defined according
to the regional regulations for BRID (e.g. message set of ASTM
F3411.19 or ASD-STAN prEN 4709-002 P1) and optionally
according to regional mean of compliance documents.
Use of U2X (UAV to everything) for DAA (detect and
avoid):
the content of the messages for DAA are defined according
to the regional regulations for DAA and is out of scope of this
specification.

According to various embodiments of the disclosure, UAV control signaling may include remote UE identification (used when remotely transmitting a UE identifier of an unmanned vehicle), a remote UE identification request (used when remotely requesting transmission of a UE identifier of an unmanned vehicle), remote UE positioning information (used when remotely transmitting position information of an unmanned vehicle), a remote UE positioning request (used when remotely requesting position information of an unmanned vehicle), remote UE path information (used when remotely transmitting a driving path of an unmanned vehicle), a remote UE path request (used when remotely requesting a driving path of an unmanned vehicle), detection and avoidance (DAA) control (used to notify that a collision of an unmanned vehicle has been detected, or to indicate to avoid a collision), etc., and UAV control signaling may be defined as at least one of PC5-S signaling, a PC5-RRC message, or PC5 user data.

Unmanned vehicles used in the disclosure may include both unmanned aerial vehicles and urban air mobilities. Of course, the disclosure is not limited to the example above, and the unmanned vehicles may include any form of vehicle without a person on board, in addition to unmanned aerial vehicles and urban air mobilities.

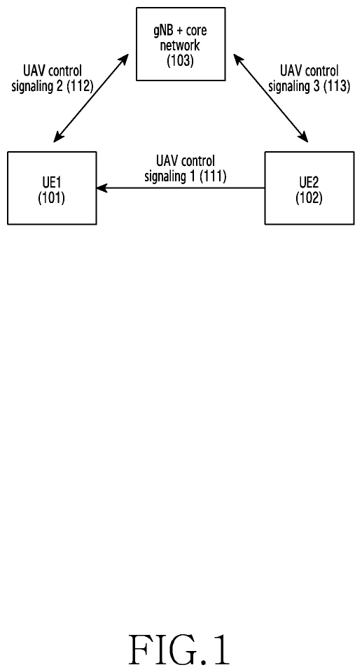

FIG. 1 is a diagram illustrating a system supporting unmanned vehicles in a wireless communication system according to an embodiment of the disclosure.

Referring to FIG. 1, UE1 101 and UE2 102 are UEs of a wireless communication system supporting unmanned vehicles. For example, UE1 101 may correspond to a UE managed by an agency regulating unmanned vehicles. UE2 102 may correspond to a UE mounted on an unmanned vehicle. For another example, UE1 101 and UE2 102 may correspond to UEs mounted on an unmanned vehicle. UE1 101 and UE2 102 may be connected to a core network 103 via a base station 103. UE2 102 may perform broadcast transmission (or groupcast transmission or one-way unicast transmission) of UAV control signaling to UE1 101 via a direct communication interface (e.g., PC5, sidelink). A scenario example based on FIG. 1, in which UE1 101 and UE2 102 transmit and receive unmanned vehicle control signaling, is as follows. For identification of information (authentication information, user registration information, etc.) on an operating unmanned vehicle, UE2 102 may transmit its own identification information to UE1 101 by using a direct communication interface (e.g., PC5, sidelink). UE1 101 may be a UE (e.g., a UE managed by an agency regulating unmanned vehicles) which manages unmanned vehicles. UE2 102 may be a UE mounted on an unmanned vehicle. For example, identification information of UE2 102 may be transmitted by being included in UAV control signaling 1 111. UE1 101 having received the identification information of UE2 102 may transmit UAV control signaling 2 112 to at least one 103 of the base station or the core network so as to acquire additional information, such as user registration information and authentication information for UE2 102, and in response to a request of UE1 101, at least one 103 of the base station or the core network may transmit UAV control signaling 2 112 including the additional information for UE2 102 to UE1 101. As another embodiment, if UE1 101 determines that it is necessary to indicate flight suspension to UE2 102, UE1 101 may request flight suspension of UE2 102 via at least one 103 of the base station or the core network, and at least one 103 of the base station or the core network may transmit UAV control signaling 3 113 including flight suspension information to UE2 102. UE1 101 may transmit and receive at least one or a combination of UAV control signaling 2 112 and UAV control signaling 3 113 for the purpose of providing UE2 102 with allowed flight zone information.

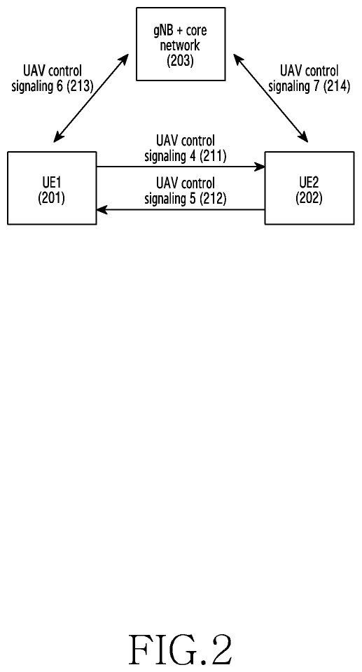

FIG. 2 is a diagram illustrating a scenario supporting unmanned vehicles in the wireless communication system.

Referring to FIG. 2, UE1 201 and UE2 202 are UEs of the wireless communication system supporting unmanned vehicles. For example, UE1 201 may correspond to a UE managed by an agency regulating unmanned vehicles. UE2 202 may correspond to a UE mounted on an unmanned vehicle. For another example, UE1 201 and UE2 202 may correspond to UEs mounted on an unmanned vehicle. UE1 201 and UE2 202 may be connected to at least one 203 of a base station or a core network. UE1 201 and UE2 202 may be connected to the core network 203 via the base station 203.

According to an embodiment of the disclosure, UE1 201 and UE2 202 may perform broadcast transmission (or groupcast transmission or one-way/two-way unicast transmission) of UAV control signaling via a direct communication interface (e.g., PC5, sidelink).

A scenario example based on FIG. 2, in which UE1 201 and UE2 202 transmit and receive unmanned vehicle control signaling, is as follows. UE1 201 managed by the agency regulating unmanned vehicles may transmit, using the direct communication interface (e.g., PC5, side link), UAV control signaling 4 211 for requesting transmission of identification information from UE2 202 mounted on the unmanned vehicle so that the agency regulating unmanned vehicles is able to identify information (authentication information, user registration information, etc.) on the operating unmanned vehicle.

UE2 202 may transmit UAV control signaling 5 212 including its own identification information to UE1 201 by using the direct communication interface. UE1 201 having received the identification information of UE2 202 may transmit UAV control signaling 6 213 to at least one 203 of the base station or the core network so as to acquire additional information, such as user registration information and authentication information for UE2 202, and in response to the request of UE1 201, at least one 203 of the base station or the core network may transmit UAV control signaling 6 213 including the additional information for UE2 202 to UE1 201.

Similarly, UAV control signaling 7 214 may be transmitted to and received from at least one 203 of the base station or the core network to control so as to control or provide information to UE2 202. At least one or a combination of UAV control signaling 4 211, UAV control signaling 5 212, UAV control signaling 6 213, and UAV control signaling 7 214 may be transmitted and received in order for UE1 201 to request flight suspension of UE2 202 or to provide information on allowed flight zones.

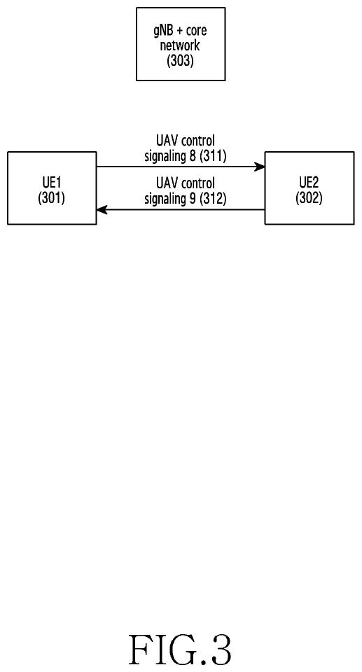

FIG. 3 is a diagram illustrating a scenario supporting unmanned vehicles in the wireless communication system according to an embodiment of the disclosure.

Referring to FIG. 3, UE1 301 and UE2 302 are UEs of the wireless communication system supporting unmanned vehicles. UE1 301 and UE2 302 are UEs of the wireless communication system supporting unmanned vehicles. For example, UE1 301 may correspond to a UE managed by an agency regulating unmanned vehicles. UE2 302 may correspond to a UE mounted on an unmanned vehicle. For another example, UE1 301 and UE2 302 may correspond to UEs mounted on an unmanned vehicle. UE1 301 and UE2 302 may be connected to at least one 303 of a base station or a core network. UE1 301 and UE2 302 may be connected to the core network via the base station, but, in the scenario of FIG. 3, it is assumed that a direct communication interface (e.g., PC5, sidelink) is used for transmitting and receiving UAV control signaling. UE1 301 and UE2 302 may perform broadcast transmission (or groupcast transmission or one-way/two-way unicast transmission) of UAV control signaling via the direct communication interface. A scenario example based on FIG. 3, in which UE1 301 and UE2 302 transmit and receive unmanned vehicle control signaling, is as follows.

According to an embodiment of the disclosure, UE1 301 managed by the agency regulating unmanned vehicles may transmit, using the direct communication interface, UAV control signaling 8 311 for requesting transmission of identification information from UE2 302 mounted on the unmanned vehicle so that the agency regulating unmanned vehicles is able to identify information (authentication information, user registration information, etc.) on the operating unmanned vehicle.

UE2 302 may transmit UAV control signaling 9 312 including its own identification information to UE1 301 by using the direct communication interface. As another embodiment, UE2 302 may transmit UAV control signaling 9 312 including its own identification information without receiving UAV control signaling 8 311 including request information of UE1 301. At least one or a combination of UAV control signaling 8 311 and UAV control signaling 9 312 may be transmitted and received in order for UE1 301 to request flight suspension of UE2 302 or to provide information on allowed flight zones.

According to the embodiments of FIGS. 1, 2, and 3, when both UE1 301 and UE2 302 are UEs mounted on unmanned vehicles, UAV control signaling transmitted and received by UE1 301 and UE2 302 may correspond to signaling including movement paths, positions (e.g., 3D position information), etc. of the UEs or signaling for establishing direct communication connections and establishing direct communication connection sessions so as to exchange messages including the movement paths, positions (e.g., 3D position information) of the UEs, etc.

According to the embodiments of FIGS. 1, 2, and 3, when UE1 301 and UE2 302 transmit and receive UAV control signaling via the direct communication interface (e.g., PC5, sidelink), UE1 301 and UE2 302 should acquire sidelink radio bearer configuration information corresponding to each UAV control signaling. A sidelink radio bearer corresponding to UAV control signaling may be configured to be one or more, and may correspond to at least one of a signaling radio bearer or a data radio bearer. If UAV control signaling corresponds to a PC5-signaling message or corresponds to a PC5 RRC message, a sidelink radio bearer thereof may be configured as a signaling bearer. If UAV control signaling corresponds to user data, a sidelink radio bearer thereof may be configured as a data bearer.

The sidelink radio bearer applicable to UAV control signaling may be at least one of a fixed (specified) radio bearer, a default radio bearer, and a configurable (configured) radio bearer. The fixed (specified) radio bearer may be a radio bearer in which configuration parameters are specified in the specification. The default radio bearer may be a radio bearer in which configuration parameters may be updated by configuration signaling of the base station. The configured radio bearer may be a radio bearer in which configuration parameters may be acquired by SIB signaling transmitted by the base station, dedicated RRC signaling transmitted by the base station, or pre-configured (pre-configuration) information.

When one sidelink radio bearer corresponding to each UAV control signaling is configured, the sidelink radio bearer may be configured as a signaling radio bearer (SL-SRB X) or configured as a data radio bearer (SL-DRB Y).

The sidelink radio bearer corresponding to each UAV control signaling may be configured for each cast type (broadcast, groupcast, or unicast) of UAV control signaling. For example, if UAV control signaling that is to be transmitted by UE1 301 is a broadcast type, UE1 301 may transmit the UAV control signaling by using a sidelink radio bearer configured for UAV control signaling of the broadcast type. For example, a sidelink signaling bearer for broadcast use may be configured as SL-SRB A, a sidelink signaling bearer for groupcast use may be configured as SL-SRB B, and a sidelink signaling bearer for unicast use may be configured as SL-SRB C. As another embodiment, a sidelink data bearer for broadcast use may be configured as SL-DRB A, a sidelink data bearer for groupcast use may be configured as SL-DRB B, and a sidelink data bearer for unicast use may be configured as SL-DRB C.

Alternatively, a sidelink radio bearer corresponding to each UAV control signaling may be configured for each message type of UAV control signaling. For example, if UAV control signaling that is to be transmitted by UE1 301 is a message type for requesting identification information of UE2 302, UE1 301 may transmit the UAV control signaling by using a sidelink radio bearer configured for identification information request UAV control signaling.

For example, if UAV control signaling that is to be transmitted by UE2 302 is a message type for the identification information of UE2 302, UE2 302 may transmit the UAV control signaling by using a sidelink radio bearer configured for identification information UAV control signaling. The sidelink radio bearer configured for each message type of UAV control signaling may be configured as either a signaling bearer (SL-SRB) or a data bearer (SL-DRB).

Alternatively, the sidelink radio bearer corresponding to each UAV control signaling may be configured for each QoS profile of UAV control signaling. For example, a PQI value may be configured according to a QoS profile of each UAV control signaling, and a sidelink radio bearer may be configured for the PQI value.

For example, when it is assumed that PQI values configured for UAV control signaling defined in the system are 1, 2, and 3, PQI=1 may be configured for signaling bearer A (SL-SRB A), PQI=2 may be configured for signaling bearer B (SL-SRB B), and PQI=3 may be configured for signaling bearer C (SL-SRB C). When it is assumed that a PQI value is 2 according to a QoS profile configured for UAV control signaling 4 that is to be transmitted by UE1 301, UE1 301 may transmit UAV control signaling 4 by using signaling bearer B.

In addition, according to an embodiment, PQI=1 may be configured for data bearer A (SL-DRB A), PQI=2 may be configured for data bearer B (SL-SRB B), and PQI=3 may be configured for data bearer C (SL-DRB C). When it is assumed that a PQI value is 3 according to a QoS profile configured for UAV control signaling 8 that is to be transmitted by UE1 301, UE1 301 may transmit UAV control signaling 8 by using data bearer C.

An embodiment of a QoS profile applicable to UAV control signaling and a corresponding PQI configuration is as follows. A QoS profile of UAV control signaling or a PQI corresponding to the QoS profile may be included in a message, i.e., a SidelinkUEInformationNR message, when a UE transmits the message, wherein this message is to request transmission resource allocation for the UAV control signaling from a base station. A QoS profile or a PQI may be included in a message, i.e., a UEAssistanceInformation message, when the UE transmits the message, wherein the UEAssistanceInformation message is to provide assistance information to enable the base station to configure periodic transmission resources for UAV control signaling which may be periodically transmitted. A QoS profile or a PQI may be included in a message, i.e., a SidelinkUEInformationNR message, when the UE transmits the message, wherein this message is to provide assistance information for the base station to configure a configurable radio bearer (configured sidelink radio bearer) among sidelink radio bearers which will be used when UAV control signaling is transmitted.

A QoS profile required by general sidelink communication data may include information on a PQI value, a resource type (one of GBR, non-GBR, and delay critical GBR), a packet delay budget, an packet error rate, an averaging window, a maximum data burst volume, a GFBR transmission rate, an MFBR transmission rate, and a range (a message transmission range). UAV control signaling may be used to transfer control information for the UE, so that data transmission rate information may be unnecessary for the QoS profile of the UAV control signaling. A QoS profile that may be configured for UAV control signaling may include information on a PQI value, a packet delay budget, a packet error rate, and a range.

The followings are options available in a case where QoS profile information of UAV control signaling that is to be transmitted by the UE is informed to the base station or a counterpart UE.

Option 1: When a QoS profile is configured for UAV control signaling, a standardized PQI value may be configured for the QoS profile. The standardized PQI value may be expressed as an integer value. The UE may inform the base station or the counterpart UE of the PQI value of the UAV control signaling. The base station or the counterpart UE may derive, based on the PQI value, QoS profile information of the UAV control signaling.

Option 2: When a QoS profile is configured for UAV control signaling, a PQI value may not be configured for the QoS profile. That is, when a non-standardized PQI is configured, information on a packet delay budget, a packet error rate, and a range may be included in addition to PQI. The UE may inform the base station or the counterpart UE of the information included in the QoS profile of the UAV control signaling.

In addition, according to an embodiment, a QoS profile may not be configured for UAV control signaling. In this case, unlike a general user packet, QoS requirements may not be defined for UAV control signaling, so that a QoS profile may not be configured for the UAV control signaling.

According to an embodiment, when a QoS profile is not configured for UAV control signaling, there may be a case where the UE needs to provide PQI or QoS profile information to the base station or another UE. For example, the UE may need to provide the information in a case where the base station configures a transmission resource mode of UAV control signaling or allocates transmission resources, in a case where the base station configures a sidelink bearer of the UAV control signaling, and in a case where the base station configures periodic transmission resources on which the UAV control signaling may be periodically transmitted. In this case, the UE may configure a default QoS profile or a default PQI for the purpose of transferring QoS profile or PQI information for the UAV control signaling to the base station or another UE.

In addition, according to an embodiment, when a QoS profile cannot be configured for UAV control signaling, the UE may select a non-used PQI to configure a PQI for the UAV control signaling for the purpose of transferring QoS profile or PQI information for the UAV control signaling to the base station or another UE.

When the UE selects transmission resources for transmitting UAV control signaling or determines whether to transmit a MAC PDU including the UAV control signaling via the selected resources, the UE may use a packet delay budget configured for the UAV control signaling.

For example, when selecting resources for transmitting the UAV control signaling, the transmission UE may select a resource reservation interval value corresponding to a time longer than a packet delay budget (or a residual packet delay budget) required by the UAV control signaling.

In addition, according to an embodiment, when selecting resources for transmitting the UAV control signaling, the transmission UE may select time/frequency resources by considering the packet delay budget (or the residual packet delay budget) required by the UAV control signaling.

In addition, according to an embodiment, the transmission UE may determine not to transmit the UAV control signaling when determining that the UAV control signaling cannot be transmitted within the required packet delay budget (or the remaining packet delay budget) by using the selected resources. Of course, the disclosure is not limited to the example above.

A transmission resource pool may need to be configured for the transmission UE to transmit UAV control signaling. As an example, a transmission resource pool for UAV control signaling use may be configured separately from a transmission resource pool for general sidelink communication use or a transmission resource pool for sidelink discovery use. Of course, the disclosure is not limited to the example above.

In addition, according to an embodiment, a transmission resource pool for UAV control signaling use may be configured in common with a transmission resource pool used for general sidelink communication use (and/or a transmission resource pool for sidelink discovery use). When HARQ feedback for UAV control signaling is required from a reception UE, a transmission resource pool for UAV control signaling use may include PSFCH resources. When HARQ feedback for the UAV control signaling is not required from the reception UE, the transmission resource pool for UAV control signaling use may not include PSFCH resources.

According to an embodiment, for a method of allocating UAV control signaling transmission resources, either mode 1 scheduled by the base station or mode 2 in which the transmission UE directly allocates transmission resources may be used. Of course, the disclosure is not limited to the example above. In addition, mode 1 or mode 2 applied to UAV control signaling transmission resource allocation may be the same as or similar to operation of mode 1 or mode 2 applied to transmission resource allocation in general sidelink communication.

In an embodiment, if a UAV control signaling transmission resource pool and a general sidelink communication transmission resource pool (and/or a sidelink discovery transmission resource pool) are configured respectively, the UE may determine that the UAV control signaling transmission resource pool has been configured separately, so as to select transmission resources from the UAV control signaling transmission resource pool when UAV control signaling needs to be transmitted.

For example, if the UAV control signaling transmission resource pool is configured separately, and the transmission resource allocation method is configured to mode 2, the transmission UE that is to transmit UAV control signaling may perform an operation of directly selecting transmission resources from the UAV control signaling transmission resource pool. The operation of directly selecting the transmission resources from the UAV control signaling transmission resource pool may be performed based on sensing in the same manner as the mode 2 operation of general sidelink communication. Of course, the disclosure is not limited to the example above.

In an embodiment, if a UAV control signaling transmission resource pool is not configured, and a general sidelink communication transmission resource pool (and/or a sidelink discovery transmission resource pool) is configured, the UE may use the general sidelink communication transmission resource pool (and/or the sidelink discovery transmission resource pool) as a common pool for UAV control signaling transmission and general sidelink communication transmission (and/or sidelink discovery transmission). Of course, the disclosure is not limited to the example above.

According to an embodiment, if a general sidelink communication transmission resource pool (and/or a sidelink discovery transmission resource pool) is configured to be used in common, and the transmission resource allocation method is configured to mode 2, the UE that is to transmit UAV control signaling may perform an operation of directly selecting transmission resources from the common resource pool. The transmission resource selecting operation may be performed based on sensing in the same manner as the mode 2 operation of general sidelink communication. When the common resource pool is used, the selected resources may be used to transmit at least one of a packet for UAV control signaling or general sidelink communication use or a sidelink discovery message (one with a higher transmission priority on a logical channel is selected among those buffered in the transmission UE).

A source identifier (or a destination identifier from the perspective of a counterpart UE) of a UE mounted on an unmanned vehicle may be used to distinguish the UE when transmitting and receiving UAV control signaling via a UE direct communication interface.

For example, when UAV control signaling is transmitted and received in the unicast mode, a destination identifier of the UAV control signaling corresponds to a source identifier of a reception UE. When UAV control signaling is transmitted and received in the broadcast mode, a destination identifier of the UAV control signaling may be configured separately from a source identifier of the reception UE. The destination identifier of the UAV control signaling transmitted and received in the broadcast mode may be selected from the same pool as that for a destination identifier used in the broadcast mode of general sidelink communication or for a destination identifier used in the broadcast mode of sidelink discovery, and may be selected from a different pool.

In addition, when UAV control signaling is transmitted and received in the groupcast mode, a destination identifier of the UAV control signaling may be configured separately from a source identifier of the reception UE. The destination identifier of the UAV control signaling transmitted and received in the groupcast mode may be selected from the same pool as that for a destination identifier used in the groupcast mode of general sidelink communication or for a destination identifier used in the groupcast mode of sidelink discovery, and may be selected from a different pool.

In addition, when UAV control signaling is transmitted and received in the unicast mode, a source identifier of the transmission UE and a source identifier of the reception UE for the UAV control signaling may be selected from the same pool as that for an identifier used in the unicast mode of general sidelink communication or for an identifier used in the unicast mode of sidelink discovery, or may be selected from a different pool.

In a case where a transmission resource pool has been configured separately for UAV control signaling use, that is, a case where a general sidelink communication transmission resource pool (and/or a sidelink discovery transmission resource pool) and the UAV control signaling transmission resource pool are configured respectively, and a destination identifier of UAV control signaling is selected from a pool different from that for a destination identifier used in general sidelink communication or in sidelink discovery, an embodiment of an operation of the transmission UE, which includes UAV control signaling, is as follows. This operation may be processed in a MAC entity of the transmission UE. Since the transmission UE may transmit only UAV control signaling in the UAV control signaling transmission resource pool, a destination identifier corresponding to the UAV control signaling may be selected.

TABLE 2
With dedicated SL resource pool for UAV control signaling
configured, when a SL grant is selected from dedicated SL resource
pool for UAV control (in case of new transmission),
TX UE selects a destination layer-2 ID associated to UAV
control signaling.
With dedicated SL resource pool for UAV control signaling
configured, when a SL grant is selected from other SL resource pool
e.g., SL communication resource pool of SL discovery resource
pool (in case of new transmission),
TX UE selects a destination layer-2 ID associated to other
SL purpose (discovery, NR SL comm)

In a case where a transmission resource pool has not been configured separately for UAV control signaling use, a general sidelink communication transmission resource pool (and/or a sidelink discovery transmission resource pool) is used in common, and a destination identifier of UAV control signaling is selected from a pool different from that for a destination identifier used in general sidelink communication or in sidelink discovery, an embodiment of an operation of the transmission UE, which includes UAV control signaling, is as follows. This operation may be processed in a MAC entity of the transmission UE. The transmission UE may transmit UAV control signaling, SL communication, and SL discovery in the transmission resource pool to be used in common, so that a destination identifier corresponding to the UAV control signaling, a destination identifier corresponding to the SL communication, or a destination identifier corresponding to the SL discovery may be selected.

TABLE 3

Without dedicated SL resource pool for UAV control signaling
configured, when a SL grant is selected from shared SL resource
pool e.g., SL communication resource pool or SL discovery
resource pool (in case of new transmission),
TX UE selects a destination layer-2 ID associated to UAV
control signaling, discovery or NR SL communication.

The operations of Table 2 and Table 3 provide descriptions for the operation of selecting a destination identifier among the operations of configuring a MAC PDU to be transmitted in transmission resources selected from the transmission resource pool by the transmitting UE, and a detailed description for a logical channel prioritization procedure for configuring the MAC PDU will be omitted in the disclosure.

According to an embodiment of the disclosure, when UAV control signaling is transmitted in the unicast mode or the groupcast mode, the presence or absence of HARQ feedback for the UAV control signaling may be configured. HARQ feedback enabled or HARQ feedback disabled may be configured for the UAV control signaling, that is, a logical channel mapped to a sidelink bearer of the UAV control signaling.

When UAV control signaling is transmitted in the unicast mode, if HARQ feedback enabled is configured, the reception UE may determine whether reception is successful for a transport block including the UAV control signaling, and may report ACK or NACK for the corresponding HARQ process to the transmission UE by using PSFCH transmission resources.

When UAV control signaling is transmitted in the groupcast mode, if HARQ feedback enabled is configured, the reception UE may determine whether reception is successful for a transport block including the UAV control signaling, and report ACK or NACK for the corresponding HARQ process to the transmission UE by using PSFCH transmission resources (HARQ ACK-NACK mode), or the reception UE may determine whether reception is successful for the transport block including the UAV control signaling, and report, if reception is unsuccessful, NACK for the corresponding HARQ process to the transmission UE by using the PSFCH transmission resources (HARQ NACK only mode).

When UAV control signaling is transmitted in the groupcast mode, if HARQ feedback is enabled, a method of receiving HARQ NACK from only a reception UE within a specific distance area may be provided, and the transmission UE may add location information (e.g., a zone ID) thereof and an effective communication distance (e.g., a communication range) for receiving the UAV control signaling to control information (SCI) associated with the UAV control signaling, so as to transmit the control information to the reception UE.

According to an embodiment of the disclosure, the followings are reception UE operations of receiving and processing UAV control signaling in a case where a separate transmission resource pool is configured for UAV control signaling transmission in addition to a general sidelink communication transmission resource pool (and/or a sidelink discovery transmission resource pool) and in a case where a separate transmission resource pool is not configured for UAV control signaling transmission. This embodiment may be applied to a case where UAV control signaling is transmitted in the broadcast mode or groupcast mode.

TABLE 4
For each PSSCH duration where a transmission takes place for the
sidelink process, one TB and the associated HARQ information is
received from the sidelink HARQ entity.
For each received TB and associated sidelink transmission
information, the sidelink process shall:
1> if this is a new transmission:
2> attempt to decode the received data.
1> else if this is a retransmission:
2> if the data for this TB has not yet been successfully decoded:
3> instruct the physical layer to combine the received data with
the data currently in the soft buffer for this TB and attempt to decode
the combined data.
1> if the data which the MAC entity attempted to decode was
successfully decoded for this TB; or
1> if the data for this TB was successfully decoded before:
2> if this is the first successful decoding of the data for this TB:
3> (case 1) if the data for this TB is received in a grant from dedicated
resource pool for UAV control:
4> if this TB is associated to groupcast or broadcast and the DST
field of the decoded MAC PDU subheader is equal to the 8 MSB of
any of the destination layer-2 ID(s) of the UE for which the 16 LSB
are equal to the destination ID in the corresponding SCI:
5> deliver the decoded MAC PDU to the disassembly and
demultiplexing entity.
3> (case 2) else if the data for this TB is received in a grant from
shared resource pool with sidelink communication (and/or sidelink
discovery)
4> if this TB is associated to unicast, the DST field of the
decoded MAC PDU subheader is equal to the 8 MSB of any of the
source layer-2 ID(s) of the UE for which the 16 LSB are equal to the
destination ID in the corresponding SCI, and the SRC field of the
decoded MAC PDU subheader is equal to the 16 MSB of any of the
destination layer-2 ID(s) of the UE for which the 8 LSB are equal to
the source ID in the corresponding SCI; or
4> if this TB is associated to groupcast or broadcast and the DST
field of the decoded MAC PDU subheader is equal to the 8 MSB of
any of the destination layer-2 ID(s) of the UE for which the 16 LSB
are equal to the destination ID in the corresponding SCI:
5> deliver the decoded MAC PDU to the disassembly and
demultiplexing entity.
NOTE: If this TB is associated to unicast and this TB is the first TB
of a logical channel which associated LCID is equal to 0 or 1, and
the DST field of the decoded MAC PDU subheader is equal to the 8
MSB of any of the source layer-2 ID(s) of the UE for which the 16
LSB are equal to the destination ID in the corresponding SCI, deliver
the decoded MAC PDU to the disassembly and demultiplexing
entity. Whether the TB is the first TB can be determined based on the
source layer-2 ID and destination layer-2 ID pair.
2> consider the sidelink process as unoccupied.
1> else:
2> instruct the physical layer to replace the data in the soft
buffer for this TB with the data which the MAC entity attempted to
decode

Case 1 for the reception UE operations according to the embodiment may be as follows.

When a UAV control signaling transmission resource pool is configured separately in addition to a general sidelink communication transmission resource pool (and/or a sidelink discovery transmission resource pool), a reception UE interested in reception of UAV control signaling may monitor the UAV control signaling transmission resource pool.

The reception UE may receive control information (SCI) received on resources of the UAV control signaling transmission resource pool and a transport block associated therewith, and process data of the transport block. The reception UE may combine a destination address included in the received control information (SCI) and a destination address included in a MAC PDU subheader of the data of the transport block, so as to determine whether corresponding UAV control signaling is associated with a destination address (a broadcast destination address or groupcast destination address) that the reception UE is interested in. If the data of the transport block is determined to be the destination address (the broadcast destination address or groupcast destination address) that the reception UE is interested in, the reception UE may transfer a corresponding MAC PDU to a disassembly and demodulation block of its own MAC entity. The reception UE may no longer process (e.g., may delete or discard) data of a transport block, which is determined to be data other than the destination address that the reception UE is interested in, and may continue monitoring resources of the UAV control signaling transmission resource pool so as to process a received transport block.

In addition, case 2 for the reception UE operations according to the embodiment may be as follows.

When only a general sidelink communication transmission resource pool (and/or a sidelink discovery transmission resource pool) is configured, and thus the general sidelink communication transmission resource pool (and/or the sidelink discovery transmission resource pool) is used in common for UAV control signaling transmission, a reception UE that is interested in receiving UAV control signaling may monitor the general sidelink communication transmission resource pool (and/or the sidelink discovery transmission resource pool) which is the common resource pool configured for UAV control signaling transmission. The reception UE may receive control information (SCI) received on resources of the common resource pool and a transport block associated therewith, and process data of the transport block.

The reception UE may combine a destination address included in the received control information (SCI) and a destination address included in a MAC PDU subheader of the data of the transport block, so as to determine whether corresponding UAV control signaling is associated with a destination address (a broadcast destination address or groupcast destination address) that the reception UE is interested in. If the data of the transport block is determined to be the destination address (the broadcast destination address or groupcast destination address) that the reception UE is interested in, the reception UE may transfer a corresponding MAC PDU to a disassembly and demodulation block of its own MAC entity. The reception UE may no longer process (e.g., may delete) data of a received transport block determined to correspond to the unicast mode, or data of a received transport block which is determined to correspond to the broadcast mode or groupcast mode but has a destination address other than the destination address that the reception UE is interested in, and may continue monitoring resources of the UAV control signaling transmission resource pool so as to process a received transport block.

According to an embodiment of the disclosure, when a sidelink bearer is configured for UAV control signaling, and a sidelink signaling bearer (SL-SRB) is configured to be used, when a PDCP entity of the reception UE transfers a PDCP SDU including the received UAV control signaling to a higher layer (e.g., a prose layer), the PDCP SDU may be transferred with indication information indicative of the UAV control signaling. The higher layer may configure and process at least one or a combination of UAV control signaling, a sidelink discovery message, and PC5-S signaling related to general sidelink communication.

The PDCP entity of the reception UE may transfer, to the higher layer, both the received PDCP SDU and the indication information indicating whether a received packet is UAV control signaling, a sidelink discovery message, or PC5-S signaling related to general sidelink communication. The higher layer receives both the PDCP SDU and the indication information indicating whether the received packet is UAV control signaling, a sidelink discovery message, or PC5-S signaling related to general sidelink communication, and identify whether the PDCP SDU is UAV control signaling, a sidelink discovery message, or PC5-S signaling related to general sidelink communication. An embodiment of the operation in which the PDCP entity of the reception UE notifies the higher layer of the indication information of the received packet is as follows.

TABLE 5

[sidelink receive operation]
For sidelink reception of the SLRB, the UE shall follow the
procedures in clause 5.2.2 of 3GPP TS 38.323 with following
modification:
perform the header decompression using ROHC as specified
in clause 5.7.5 of 3GPP TS 38.323, if SDU Type is IP.
NOTE: For reception of sidelink SRBs except sidelink SRB3, the
UE may deliver the PDCP SDU to the upper layer along with an
indication whether it is PC5-S message or sidelink discovery
message or UAV control signalling message.

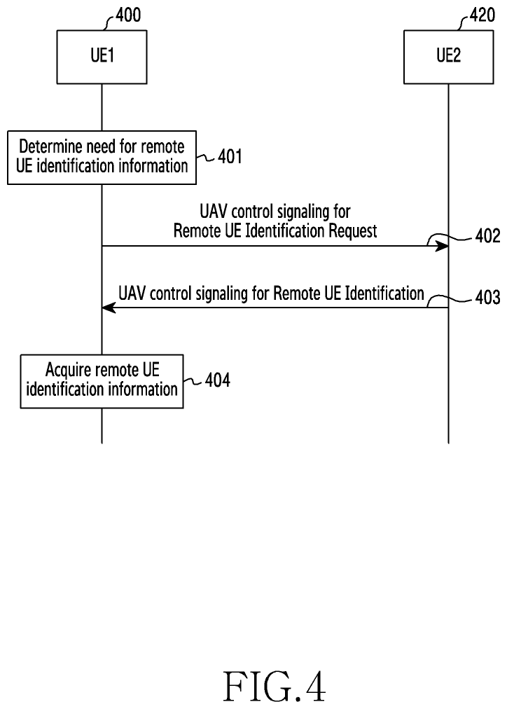

FIG. 4 is a diagram illustrating a signal flow of UEs in the wireless communication system supporting unmanned vehicles according to an embodiment of the disclosure.

Referring to FIG. 4, UE1 400 and UE2 420 are UEs supporting transmission and reception of UAV control signaling, and UE1 400 is a UE managed by a regulatory agency, and UE2 420 is an unmanned aerial vehicle UE. FIG. 4 illustrates a signal flow of UEs in a scenario supporting unmanned vehicles in the wireless communication system according to an embodiment of the disclosure.

In operation 401, UE1 400 may determine a need to remotely acquire identification information of an unmanned aerial vehicle, and determine to transmit a remote UE identification information request by using a UE direct interface.

In operation 402, UE1 400 may configure a UAV control signaling message for remotely requesting identification information of the unmanned aerial vehicle, and transmit UAV control signaling via the UE direct communication interface. In operation 402, UE1 400 may transmit the UAV control signaling by using a sidelink bearer configured for UAV control signaling message use. In operation 402, UE1 400 may identify a transmission resource pool configured for UAV control signaling message use (a separately configured transmission resource pool or a common pool for UAV control signaling use) and transmit the UAV control signaling by using transmission resources allocated from the pool. If UE1 400 has been connected to a base station (RRC_CONNECTED state), or is connected to the base station because no transmission resource pool for transmitting the UAV control signaling has been configured (transition to the RRC_CONNECTED state), UE1 400 may transmit a SidelinkUEInformationNR message so as to be configured with UAV control signaling transmission resources from the base station.

The SidelinkUEInformationNR message transmitted by UE1 400 to the base station may include at least one or a combination of a destination identifier address, a cast type, a QoS profile, or PQI information of the UAV control signaling corresponding to the remote UE identification request. The base station may configure, for UE1 400, a scheduling mode (mode 1 or mode 2) in which the UAV control signaling may be transmitted, and if mode 1 is configured, transmission resources on which UE1 400 will transmit the UAV control signaling may be allocated.

If UE1 400 is in an RRC_IDLE state, an RRC_INACTIVE state, or an out-of-coverage state and it is determined that there is a transmission resource pool configured for UAV control signaling transmission, UE1 400 may select resources on its own from the transmission resource pool for UAV control signaling transmission, so as to transmit the UAV control signaling on the selected resources. If UE2 420 is interested in receiving UAV control signaling, UE2 420 may monitor the pool configured for UAV control signaling use, and determine if there is a packet that UE2 420 needs to receive.

MAC entity operations of UE2 420 interested in receiving UAV control signaling are as shown in Table 4. When the packet that UE2 420 needs to receive is received, a PDCP entity of UE2 420 may transmit a PDCP SDU including the UAV control signaling to its higher layer (e.g., a prose layer) while transmitting indication information indicating that the packet is UAV control signaling. The higher layer of UE2 420 may determine that the packet is UAV control signaling from UE1 400 for requesting UE identification information, and in response to this, may determine that the UE identification information of UE2 420 needs to be transmitted.

In operation 403, UE2 420 may configure a UAV control signaling message, via which the identification information of the unmanned aerial vehicle may be remotely transmitted, and transmit UAV control signaling via the UE direct communication interface. In operation 403, UE2 420 may transmit the UAV control signaling by using a sidelink bearer configured for UAV control signaling message use. In operation 403, UE2 420 may identify a transmission resource pool configured for UAV control signaling message use (a separately configured transmission resource pool or a common pool for UAV control signaling use) and transmit the UAV control signaling by using transmission resources allocated from the transmission resource pool configured for UAV control signaling use.

If UE2 420 has been connected to the base station (RRC_CONNECTED state), or is connected to the base station because no transmission resource pool for transmitting the UAV control signaling has been configured (transition to the RRC_CONNECTED state), UE2 420 may transmit a SidelinkUEInformationNR message so as to be configured with UAV control signaling transmission resources from the base station. The SidelinkUEInformationNR message transmitted by UE2 420 to the base station may include at least one or a combination of a destination identifier address, a cast type, a QoS profile, or PQI information of the UAV control signaling corresponding to the remote UE identification. The base station may configure, for UE2 420, a scheduling mode (mode 1 or mode 2) in which the UAV control signaling may be transmitted, and if mode 1 is configured, transmission resources on which UE2 420 will transmit the UAV control signaling may be allocated. If UE2 420 is in an RRC_IDLE state, an RRC_INACTIVE state, or an out-of-coverage state and it is determined that there is a transmission resource pool configured for UAV control signaling transmission, UE2 420 may select resources on its own from the transmission resource pool for UAV control signaling transmission, so as to transmit the UAV control signaling on the selected resources.

In operation 404, if UE1 400 is interested in receiving UAV control signaling, UE1 400 may monitor the pool configured for UAV control signaling use, and determine if there is a packet that UE1 400 needs to receive. MAC entity operations of UE1 400 interested in receiving UAV control signaling are as shown in Table 4. When the packet that UE1 400 needs to receive is received, a PDCP entity of UE1 400 may transmit a PDCP SDU including the UAV control signaling to its higher layer (e.g., a prose layer) while transmitting indication information indicating that the packet is UAV control signaling. The higher layer of UE1 400 may determine that the packet is UAV control signaling notifying of the UE identification information of UE2 420, and subsequently perform a predetermined procedure.

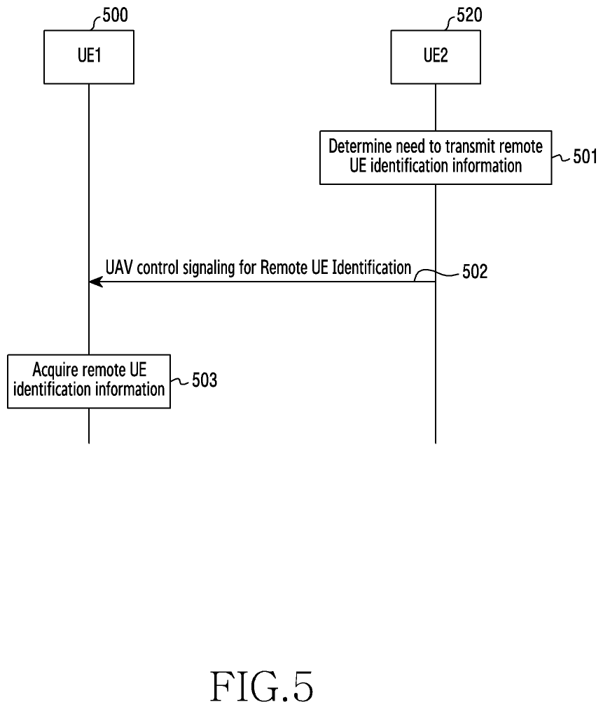

FIG. 5 is a diagram illustrating a signal flow of UEs in a scenario supporting unmanned vehicles in the wireless communication system according to an embodiment of the disclosure.

Referring to FIG. 5, UE1 500 and UE2 520 are UEs supporting transmission and reception of UAV control signaling, and UE1 500 may be a UE managed by a regulatory agency, and UE2 520 may be an unmanned aerial vehicle UE. In FIG. 5, a scenario in which a regulatory agency remotely acquires identification information of an unmanned aerial vehicle is assumed.

In operation 501, UE2 520 may determine a need to remotely transmit identification information of an unmanned aerial vehicle, and determine to transmit remote UE identification information by using a UE direct interface.

In operation 502, UE2 520 may configure a UAV control signaling message, via which the identification information of the unmanned aerial vehicle may be remotely transmitted, and transmit UAV control signaling via the UE direct communication interface. In operation 502, UE2 520 may transmit the UAV control signaling by using a sidelink bearer configured for UAV control signaling message use. In operation 502, UE2 520 may identify a transmission resource pool configured for UAV control signaling message use (a separately configured transmission resource pool or a common pool for UAV control signaling use) and transmit the UAV control signaling by using transmission resources allocated from the transmission resource pool configured for UAV control signaling use. If UE2 520 has been connected to the base station (RRC_CONNECTED state), or is connected to the base station because no transmission resource pool for transmitting the UAV control signaling has been configured (transition to the RRC_CONNECTED state), UE2 520 may transmit a SidelinkUEInformationNR message so as to be configured with UAV control signaling transmission resources from the base station.

The SidelinkUEInformationNR message transmitted by UE2 520 to the base station may include at least one or a combination of a destination identifier address, a cast type, a QoS profile, or PQI information of the UAV control signaling corresponding to the remote UE identification. The base station may configure, for UE2 520, a scheduling mode (mode 1 or mode 2) in which the UAV control signaling may be transmitted, and if mode 1 is configured, transmission resources on which UE2 520 will transmit the UAV control signaling may be allocated. If UE2 520 is in an RRC_IDLE state, an RRC_INACTIVE state, or an out-of-coverage state and it is determined that there is a transmission resource pool configured for UAV control signaling transmission, UE2 520 may select resources on its own from the transmission resource pool for UAV control signaling transmission, so as to transmit the UAV control signaling on the selected resources.

In operation 503, if UE1 500 is interested in receiving UAV control signaling, UE1 500 may monitor the pool configured for UAV control signaling use, and determine if there is a packet that UE1 500 needs to receive. MAC entity operations of UE1 500 interested in receiving UAV control signaling are as shown in Table 4. When the packet that UE1 500 needs to receive is received, a PDCP entity of UE1 500 may transmit a PDCP SDU including the UAV control signaling to its higher layer (e.g., a prose layer) while transmitting indication information indicating that the packet is UAV control signaling. The higher layer of UE1 500 may determine that the packet is UAV control signaling notifying of the UE identification information of UE2 520, and subsequently perform a predetermined procedure.

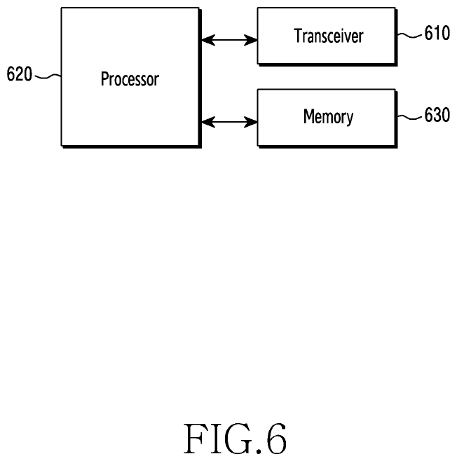

FIG. 6 is a block diagram illustrating a structure of a UE according to an embodiment of the disclosure.

As illustrated in FIG. 6, a UE of the disclosure may include a processor 620, a transceiver 600, and a memory 630. However, components of the UE are not limited to the above-described example. For example, the UE may include a larger or smaller number of components than the above-described components. In addition, the processor 620, the transceiver 610, and the memory 630 may be implemented in the form of a single chip.

According to an embodiment of the disclosure, the processor 620 may control a series of processes so that the UE can operate according to the above-described embodiments of the disclosure. The processor 620 may control the components of the UE to perform the embodiments of the disclosure by executing the programs stored in the memory 630. In addition, the processor 620 may be an application processor (AP), a communication processor (CP), a circuit, an application-specific circuit, or at least one processor.

In an embodiment, the transceiver 610 may transmit/receive signals with the base station. The signals transmitted/received with the base station may include control information and data. The transceiver 610 may include an RF transmitter configured to up-convert and amplify the frequency of transmitted signals, an RF receiver configured to low-noise-amplify received signals and down-convert the frequency thereof, and the like. However, this is only an embodiment of the transceiver 610, and the components of the transceiver 610 are not limited to the RF transmitter and the RF receiver. In addition, the transceiver 610 may receive signals through a radio channel, output the same to the processor 620, and transmit signals output from the processor 620 through the radio channel.

According to an embodiment of the disclosure, the memory 630 may store programs and data necessary for operations of the UE. In addition, the memory 630 may store control information or data included in signals transmitted/received by the UE. The memory 630 may include storage media such as a ROM, a RAM, a hard disk, a CD-ROM, and a DVD, or a combination of storage media.

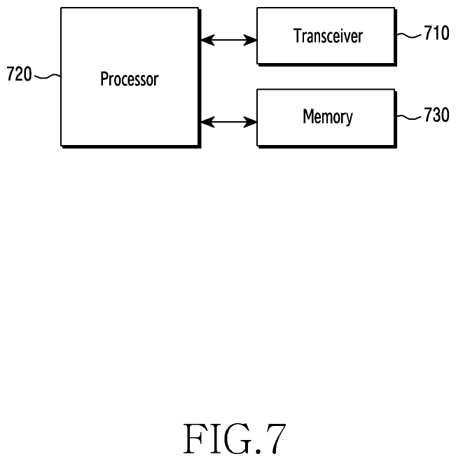

FIG. 7 is a block diagram illustrating a structure of a base station according to an embodiment of the disclosure.

As illustrated in FIG. 7, a UE of the disclosure may include a processor 720, a transceiver 710, and a memory 730. However, components of the base station are not limited to the above-described example. For example, the base station may include a larger or smaller number of components than the above-described components. In addition, the processor 720, the transceiver 710, and the memory 730 may be implemented in the form of a single chip.

According to an embodiment of the disclosure, the processor 720 may control a series of processes so that the NF can operate according to the above-described embodiments of the disclosure. The processor 720 may control the components of the base station to perform the embodiments of the disclosure by executing programs stored in the memory 730. In addition, the processor 720 may include at least one processor.

According to an embodiment of the disclosure, the transceiver 710 may transmit/receive signals with other base stations or UEs. The signals transmitted/received with other base stations or UEs may include control information and data. The transceiver 710 may include an RF transmitter configured to up-convert and amplify the frequency of transmitted signals, an RF receiver configured to low-noise-amplify received signals and down-convert the frequency thereof, and the like. However, this is only an embodiment of the transceiver 710, and the components of the transceiver 710 are not limited to the RF transmitter and the RF receiver. In addition, the transceiver 710 may receive signals through a radio channel, output the same to the processor 720, and transmit signals output from the processor 720 through the radio channel.

According to an embodiment of the disclosure, the memory 730 may store programs and data necessary for operations of the base station. In addition, the memory 730 may store control information or data included in signals transmitted/received by the base station. The memory 730 may include storage media such as a ROM, a RAM, a hard disk, a CD-ROM, and a DVD, or a combination of storage media.

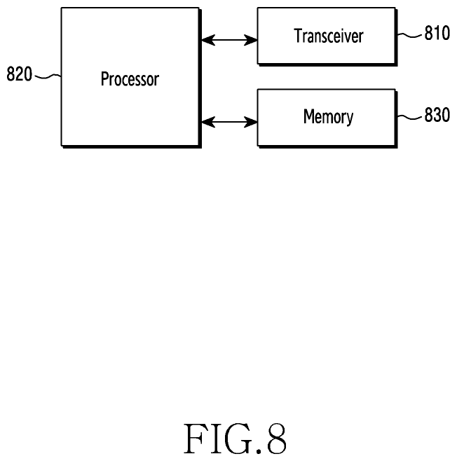

FIG. 8 is a block diagram illustrating a structure of a core network according to an embodiment of the disclosure.

As illustrated in FIG. 8, a core network of the disclosure may include a processor 820, a transceiver 810, and a memory 830. However, components of the core network are not limited to the above-described example. For example, the core network may include a larger or smaller number of components than the above-described components. In addition, the processor 820, the transceiver 810, and the memory 830 may be implemented in the form of a single chip.

According to an embodiment of the disclosure, the processor 820 may control a series of processes so that the NF can operate according to the above-described embodiments of the disclosure. The processor 820 may control the components of the core network to perform the embodiments of the disclosure by executing programs stored in the memory 830. In addition, the processor 820 may include at least one processor.

According to an embodiment of the disclosure, the transceiver 810 may transmit/receive signals with base stations. The signals transmitted/received with base stations may include control information and data. The transceiver 810 may include an RF transmitter configured to up-convert and amplify the frequency of transmitted signals, an RF receiver configured to low-noise-amplify received signals and down-convert the frequency thereof, and the like. However, this is only an embodiment of the transceiver 810, and the components of the transceiver 810 are not limited to the RF transmitter and the RF receiver. In addition, the transceiver 810 may receive signals through a radio channel, output the same to the processor 820, and transmit signals output from the processor 820 through the radio channel.

According to an embodiment of the disclosure, the memory 830 may store programs and data necessary for operations of the core network. In addition, the memory 830 may store control information or data included in signals transmitted/received by the core network. The memory 830 may include storage media such as a ROM, a RAM, a hard disk, a CD-ROM, and a DVD, or a combination of storage media. In addition, the memory 830 may include multiple memories.

The disclosure relates to a method and a device in a wireless communication system, in which signaling for controlling an unmanned aerial vehicle is defined as UAV control signaling, and the UAV control signaling is transmitted and received via a UE direct communication interface (e.g., PC5, sidelink). In the wireless communication system according to an embodiment of the disclosure, a method of configuring a sidelink bearer for transmitting and receiving UAV control signaling, a method of configuring a cast type to be used for UAV control signaling transmission, a method of configuring a QoS profile and a PQI of UAV control signaling, a method of configuring and operating a UAV control signaling transmission resource pool, a method of configuring a UAV control signaling transmission resource signaling mode, and configuring a destination identifier and a source identifier of UAV control signaling, a UE operation for transmitting UAV control signaling, a UE operation for receiving UAV control signaling, etc. may be included.

A method performed by a UE in a wireless communication system of the disclosure may include: acquiring configuration information of a sidelink bearer for transmitting and receiving UAV control signaling, and configuring the sidelink bearer; receiving a configuration of a transmission resource pool for transmitting and receiving the UAV control signaling, and processing transmission resource allocation; acquiring a QoS profile or a PQI configuration for the UAV control signaling, and reporting the QoS profile or PQI to a base station or another UE; if the QoS profile for the UAV control signaling is not configured, processing the PQI configuration and reporting the PQI to the base station or another UE; if HARQ feedback has been configured for the UAV control signaling, selecting HARQ feedback resources from the transmission resource pool; if HARQ feedback has been configured for the UAV control signaling, transmitting information indicating HARQ feedback configuration information to a reception UE by the transmission UE; determining whether the transmission resource pool is a separate or a shared transmission resource pool configured for the UAV control signaling, and processing UAV control signaling reception, by the reception UE; and determining the UAV control signaling reception and transferring both a PDCP SDU, which includes the UAV control signaling, and UAV control signaling indication information to a higher layer, by the reception UE.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a first user equipment (UE) in a wireless communication system, the method comprising:
acquiring bearer configuration information for a radio bearer for unmanned aerial vehicle (UAV) control information via a sidelink;
based on the configuration information, configuring a radio bearer for first UAV control information transmitted from the first UE to a second UE and second UAV control information transmitted from the second UE to the first UE; and
transmitting the first UAV control information to the second UE by using the configured radio bearer,
wherein the configuring of the radio bearer comprises, based on the bearer configuration information, configuring one radio bearer that is commonly used for the first UAV control information and the second UAV control information, or configuring at least one radio bearer, based on a cast type or a quality of service (QoS) profile of the first UAV control information and the second UAV control information.

2. The method of claim 1,
wherein, in case that a QoS profile corresponding to the first UAV control information has been configured, the QoS profile comprises a standardized PQI value, or comprises information on a packet delay budget (PDB), a packet error rate (PER), and a message transmission range,
wherein, in case that the QoS profile corresponding to the first UAV control information has not been configured, information related to the QoS profile comprises a default QoS profile or a default PQI, and
wherein, in case that the QoS profile corresponding to the first UAV control information is unable to be configured, the QoS profile comprises a non-used PQI.

3. The method of claim 1, further comprising:
acquiring resource pool configuration information for a resource pool,
wherein, based on the resource pool configuration information, a resource pool related to transmission of the first UAV control information and reception of the second UAV control information, and a resource pool related to sidelink communication other than transmission of the first UAV control information and reception of the second UAV control information are separately configured, or
based on the resource pool configuration information, a shared resource pool related to all of transmission of the first UAV control information, reception of the second UAV control information, and sidelink communication other than transmission of the first UAV control information and reception of the second UAV control information is configured.

4. The method of claim 3,
wherein the transmitting comprises transmitting the first UAV control information by using the configured bearer via a resource selected for transmission of the first UAV control information, the resource being selected based on the resource pool configuration information,
wherein the method further comprises, in case that the selected resource is selected from the resource pool related to transmission of the first UAV control information and reception of the second UAV control information, selecting a destination identifier included in a medium access control (MAC) protocol data unit (PDU) related to the first UAV control information transmitted in the selected resource,
wherein the method further comprises, in case that the selected resource is selected from the resource pool related to sidelink communication other than transmission of the first UAV control information and reception of the second UAV control information, selecting a destination identifier included in a MAC PDU for sidelink communication in the selected resource other than transmission of the first UAV control information and reception of the second UAV control information, and
wherein the method further comprises, in case that the selected resource is selected from the shared resource pool, selecting a destination identifier included in a MAC PDU related to the first UAV control information transmitted in the selected resource, or a destination identifier included in a MAC PDU for sidelink communication in the selected resource other than transmission of the first UAV control information and reception of the second UAV control information.

5. The method of claim 4,
wherein the selected destination identifier related to transmission of the first UAV control information is included in sidelink control information (SCI) related to the first UAV control information, and the MAC PDU including the selected destination identifier related to transmission of the first UAV control information is included in a transport block (TB) related to the SCI, and
wherein the destination identifier related to transmission of the first UAV control information is used to determine whether the second UE configured to receive the UAV control information performs de-multiplexing of the first UAV control information.

6. A method performed by a second user equipment (UE) in a wireless communication system, the method comprising:
acquiring bearer configuration information for a radio bearer for unmanned aerial vehicle (UAV) control information via a sidelink;
based on the configuration information, configuring a radio bearer for first UAV control information transmitted from a first UE to the second UE and second UAV control information transmitted from the second UE to the first UE; and
receiving the first UAV control information from the first UE by using the configured radio bearer,
wherein the configuring of the radio bearer comprises, based on the bearer configuration information, configuring one radio bearer that is commonly used for the first UAV control information and the second UAV control information, or configuring at least one radio bearer, based on a cast type or a quality of service (QoS) profile of the first UAV control information and the second UAV control information.

7. The method of claim 6,
wherein, in case that a QoS profile corresponding to the first UAV control information has been configured, the QoS profile comprises a standardized PQI value, or comprises information on a packet delay budget (PDB), a packet error rate (PER), and a message transmission range,
wherein, in case that the QoS profile corresponding to the first UAV control information has not been configured, information related to the QoS profile comprises a default QoS profile or a default PQI, and
wherein, in case that the QoS profile corresponding to the first UAV control information is unable to be configured, the QoS profile comprises a non-used PQI.

8. The method of claim 6, further comprising:
acquiring resource pool configuration information for a resource pool,
wherein, based on the resource pool configuration information, a resource pool related to reception of the first UAV control information and transmission of the second UAV control information, and a resource pool related to sidelink communication other than reception of the first UAV control information and transmission of the second UAV control information are separately configured, or
based on the resource pool configuration information, a shared resource pool related to all of reception of the first UAV control information, transmission of the second UAV control information, and sidelink communication other than reception of the first UAV control information and transmission of the second UAV control information is configured.

9. The method of claim 8,
wherein the transmitting comprises transmitting the second UAV control information by using the configured bearer via a resource selected for transmission of the first UAV control information, the resource being selected based on the resource pool configuration information,
wherein the method further comprises, in case that the selected resource is selected from the resource pool related to reception of the first UAV control information and transmission of the second UAV control information, selecting a destination identifier included in a medium access control (MAC) protocol data unit (PDU) related to the second UAV control information transmitted in the selected resource,
wherein the method further comprises, in case that the selected resource is selected from the resource pool related to sidelink communication other than reception of the first UAV control information and transmission of the second UAV control information, selecting a destination identifier included in a MAC PDU for sidelink communication in the selected resource other than reception of the first UAV control information and transmission of the second UAV control information, and
wherein the method further comprises selecting a destination identifier included in a MAC PDU related to the second UAV control information transmitted in the selected resource, or a destination identifier included in a MAC PDU for sidelink communication in the selected resource other than reception of the first UAV control information and transmission of the second UAV control information.

10. The method of claim 9,
wherein the selected destination identifier related to transmission of the second UAV control information is included in sidelink control information (SCI) related to the first UAV control information, and the MAC PDU including the selected destination identifier related to transmission of the first UAV control information is included in a transport block (TB) related to the SCI, and
wherein the selected destination identifier related to transmission of the second UAV control information is used to determine whether the first UE configured to receive the UAV control information performs de-multiplexing of the second UAV control information.

11. A first user equipment (UE) in a wireless communication system, the first UE comprising:
a transceiver; and
a controller connected to the transceiver,
wherein the controller is configured to perform:
acquiring bearer configuration information for a radio bearer for unmanned aerial vehicle (UAV) control information via a sidelink,
based on the configuration information, configuring a radio bearer for first UAV control information transmitted from the first UE to a second UE and second UAV control information transmitted from the second UE to the first UE, and
transmitting the first UAV control information to the second UE by using the configured radio bearer, and
wherein the configuring of the radio bearer comprises, based on the bearer configuration information, configuring one radio bearer that is commonly used for the first UAV control information and the second UAV control information, or configuring at least one radio bearer, based on a cast type or a quality of service (QoS) profile of the first UAV control information and the second UAV control information.

12. The first UE of claim 11,
wherein, in case that a QoS profile corresponding to the first UAV control information has been configured, the QoS profile comprises a standardized PQI value, or comprises information on a packet delay budget (PDB), a packet error rate (PER), and a message transmission range,
wherein, in case that the QoS profile corresponding to the first UAV control information has not been configured, information related to the QoS profile comprises a default QoS profile or a default PQI, and
wherein, in case that the QoS profile corresponding to the first UAV control information is unable to be configured, the QoS profile comprises a non-used PQI.

13. The first UE of claim 13,
wherein the controller is configured to further perform acquiring resource pool configuration information for a resource pool, and
wherein, based on the resource pool configuration information, a resource pool related to transmission of the first UAV control information and reception of the second UAV control information, and a resource pool related to sidelink communication other than transmission of the first UAV control information and reception of the second UAV control information are separately configured, or
based on the resource pool configuration information, a shared resource pool related to all of transmission of the first UAV control information, reception of the second UAV control information, and sidelink communication other than transmission of the first UAV control information and reception of the second UAV control information is configured.

14. The first UE of claim 13,
wherein the transmitting comprises transmitting the first UAV control information by using the configured bearer via a resource selected for transmission of the first UAV control information, the resource being selected based on the resource pool configuration information,
wherein the controller is configured to further perform, in case that the selected resource is selected from the resource pool related to transmission of the first UAV control information and reception of the second UAV control information, selecting a destination identifier included in a medium access control (MAC) protocol data unit (PDU) related to the first UAV control information transmitted on the selected resources, and
wherein the controller is configured to further perform, in case that the selected resource is selected from the resource pool related to sidelink communication other than transmission of the first UAV control information and reception of the second UAV control information, selecting a destination included in a MAC PDU for sidelink communication in the selected resource other than transmission of the first UAV control information and reception of the second UAV control information, a destination identifier included in a MAC PDU related to the first UAV control information transmitted in the selected resource, or a destination identifier included in a MAC PDU for sidelink communication in the selected resource other than transmission of the first UAV control information and reception of the second UAV control information.

15. A second user equipment (UE) in a wireless communication system, the second UE comprising:
a transceiver; and
a controller connected to the transceiver,
wherein the controller is configured to perform:
acquiring bearer configuration information for a radio bearer for unmanned aerial vehicle (UAV) control information via a sidelink,
based on the configuration information, configuring a radio bearer for first UAV control information transmitted from a first UE to the second UE and second UAV control information transmitted from the second UE to the first UE, and
receiving the first UAV control information from the first UE by using the configured radio bearer, and
wherein the configuring of the radio bearer comprises, based on the bearer configuration information, configuring one radio bearer that is commonly used for the first UAV control information and the second UAV control information, or configuring at least one radio bearer, based on a cast type or a quality of service (QoS) profile of the first UAV control information and the second UAV control information.
